(19) United States
(12) Patent Application Publication
(10) Pub. No.: US 2025/0306775 A1
(43) Pub. Date: Oct. 2, 2025

(54) METHODS AND DEVICE FOR MULTI-LEVEL PORTABLE SECURE DATA STORAGE

(71) Applicant: Rockwell Collins, Inc, Cedar Rapids, IA (US)

(72) Inventors: Gabriel W. SCHIVE, Marion, IA (US); Sean D. HOWARD, Cedar Rapids, IA (US); Meghan K. ANDERSON, Elkhorn, NE (US); Jonathan D. DRAHOS, Belle Plaine, IA (US)

(73) Assignee: Rockwell Collins, Inc., Cedar Rapids, IA (US)

(21) Appl. No.: 18/618,582

(22) Filed: Mar. 27, 2024

(51) Int. Cl. G06F 3/06

(52) U.S. Cl. CPC G06F 3/0622; G06F 3/061; G06F 3/0655; G06F 3/0679

(57) ABSTRACT

A portable data storage device includes a read/write data bus interface and a read only data bus interface to exchange data with a host device. The data storage device includes a non-volatile memory storage having a plurality of data file storage areas. The different storage areas include data files having a classification level. Each data file storage area is associated with a private key and a certificate used to authenticate the host device. The portable data storage device also includes certificate storage area that includes certificates for each data file storage area. A cryptography manager controls access to the data file storage areas through one of the data bus interfaces upon receipt of a private key that matches the certificate for an associated data file storage area.

### FIELD OF THE INVENTION

The present invention relates to storing data in a multi-level portable secure storage device using cross-domain host-authenticated storage media.

### DESCRIPTION OF THE RELATED ART

Secure lab users are restricted from using data transfer devices across multiple levels of data due to security limitations. A trusted download is for transport to unclassified areas. Data export is allowed for transmission of classified data to a secure recipient. For example, some organizations may allow data transport if the data is burned to a compact disc, printed documents, or even floppy disks. Pin code hard drives are for single classification and are of limited use. These methods of data transfer are wasteful and size limited. A write-once compact disc does not have the data storage needed to carry large files. Plus, the disc is discarded after every use.

Unencrypted non-volatile data storage and transfer may be deemed insecure. Such devices may be a universal serial bus (USB) drive or a hard drive. These devices may be lost, misplaced, or stolen. Concerns may arise over access to remnant data on these devices. Thus, these aspects of data storage do not provide useable data storage to move large amounts of data while maintaining security for classified or proprietary data.

### SUMMARY OF THE INVENTION

In some embodiments, a method for multi-level portable storage is disclosed. The method includes configuring a portable data storage device to communicate with a host device using a data bus interface. The method also includes receiving a private key at the portable data storage device from the host device. The private key corresponds to a unique digital identity. The method also includes authenticating the private key within the portable storage device. The method also includes determining the unique digital identify of the private key has access to a storage area of a plurality of storage areas within a non-volatile memory storage of the portable data storage device. The method also includes accessing at least one data file within the storage area of the non-volatile memory.

In some embodiments, a portable data storage device is disclosed. The portable data storage device includes a read only data bus interface to exchange data with a host device. The portable data storage device also includes a read/write data bus interface to exchange data with the host device. The portable data storage device also includes a non-volatile memory storage having a plurality of data file storage areas. Each of the plurality of data file storage areas is associated with a private key and a certificate. The portable data storage device also includes a certificate storage area within the plurality of data file storage areas of the non-volatile memory storage. The certificate storage area includes the certificate for each data file storage area. The portable data storage device also includes a cryptography manager to control access to a first data file storage area of the plurality of data file storage areas through the read only data bus interface or the read/write data bus interface upon receipt of the a first private key that matches a first certificate within the certificate storage corresponding to the first data file storage area.

In some embodiments, a method for secure multi-level portable secure data storage is disclosed. The method includes configuring a portable data storage device to communicate with a host device using one of a read only data bus interface and a read/write data bus interface. The method also includes receiving a first private key at the portable data storage device form the host device. The private key corresponds to a unique digital identity. The method also includes authenticating the first private key within the portable storage device using a cryptographic manager by matching the first private key to a first certificate stored within a certificate of a non-volatile data storage of the portable storage device. The method also includes determining a first data file storage having at least one data file corresponds to the first certificate. The method also includes determining a first access status for the first data file storage according to the first certificate. The method also includes enabling access to the first data file storage using the read only data bus interface or the read/write data bus interface based on the first access status.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, numerous variations are possible. For instance, structural elements and process steps may be rearranged, combined, distributed, eliminated, or otherwise changed, while remaining with the scope of the disclosed embodiments.

### BRIEF DESCRIPTION OF THE DRAWINGS

Implementations of the inventive concepts disclosed herein may be better understood when consideration is given to the following detailed description thereof. Such description makes reference to the included drawings, which are not necessarily to scale, and which some features may be exaggerated and some features may be omitted or may be represented schematically in the interest of clarity. Like reference numerals in the drawings may represent and refer to the same or similar element, feature, or function. In the drawings:

FIG. 1 illustrates a portable data storage device according to the disclosed embodiments.

FIG. 2 illustrates a block diagram of components within the portable data storage device according to the disclosed embodiments.

FIG. 3 illustrates a block diagram of components during access of the portable data storage device according to the disclosed embodiments.

FIG. 4 illustrates depicts a flow diagram for enabling multi-level portable secure data storage using cross-domain host-authenticated storage media according to the disclosed embodiments.

### DETAILED DESCRIPTION OF THE PREFERRED EMBODIMENTS

Before explaining at least one embodiment of the inventive concepts disclosed herein in detail, it is to be understood that the inventive concepts are not limited in their application to the details of construction and the arrangement of the components or steps or methodologies set forth in the following description or illustrated in the drawings. In the following detailed description of the embodiments of the inventive concepts, numerous specific details are set forth in order to provide a more thorough understanding of the inventive concepts. It will be apparent to one skilled in the art, however, having the benefit of the instant disclosure that the inventive concepts disclosed herein may be practiced without these specific details.

In other instances, well-known features may not be described in detail to avoid unnecessarily complicating the instant disclosure. The inventive concepts disclosed herein are capable of other embodiments or of being practiced or performed in various ways. Further, it is to be understood that the phraseology and terminology employed herein is for the purpose of description and should not be regarded as limiting.

As used herein, a letter following a reference numeral is intended to reference an embodiment of the feature or element that may be similar, but not necessarily identical, to a previously described element or feature bearing the same reference numeral, such as 1, 1a, or 1b. Such shorthand notations are used for purposes of convenience only, and should not be construed to limit the inventive concepts disclosed herein in any way unless expressly stated to the contrary.

Moreover, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of embodiments of the instant inventive concepts. This is done merely for convenience and to give a general sense of the inventive concepts, and “a” and “an” are intended to include one or at least one and the singular also includes plural unless it is obvious that it is meant otherwise. It will be further understood that the terms “comprises” or “comprising,” when used in this specification, specify the presence of stated features, integers, steps, operations, elements, or components, but do not preclude the presence or addition of one or more other features, integers, steps, operations, elements, components, and/or groups thereof.

As used herein, any reference to “one embodiment,” or “some embodiments” means that particular element, feature, structure, or characteristic described in connection with the embodiment is included in at least one embodiment of the inventive concepts disclosed herein. The appearances of the phrase “in some embodiments” in various places in the specification are not necessarily all referring to the same embodiment, and embodiments of the inventive concepts disclosed may include one or more of the features expressly described or inherently present herein, or any combination or sub-combination of two or more such features, along with any other features that may not necessarily be expressly described or inherently present in the instant disclosure.

The inventive concepts may be described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts, or combinations of special purpose hardware and computer instructions.

Inventive concepts may be implemented as a computer process, a computing system or as an article of manufacture such as a computer program product of computer readable media. The computer program product may be a computer storage medium readable by a computer system and encoding computer program instructions for executing a computer process. When accessed, the instructions cause a processor to enable other components to perform the functions disclosed below.

Broadly, in some embodiments, a portable data storage device includes data bus interfaces to connect to a host device. The portable data storage device includes an encryption device, a non-volatile memory storage space, and certificates and private keys. The non-volatile memory may be managed so that one or more encrypted memory areas exist within the non-volatile memory for use with multiple security levels. The portable data storage device also includes a certificate storage non-volatile memory that contains a set of certificates. The device is host operating system agnostic.

The portable data storage device includes two separate data bus interfaces. In some embodiments, the data bus interfaces may be universal serial bus (USB) interfaces, though other data bus interfaces may be implemented, such as a solid state drive (SSD) or eSATA interface. One interface may be a read/write data bus interface while the other interface may be a read only interface. Once authenticated, access goes through the appropriate data bus interface through a crypto processor then through a storage manager to an encrypted non-volatile memory device.

The portable data storage device has a certificate storage non-volatile memory. The certificate storage non-volatile memory includes a set of certificates. Each certificate corresponds to a private key that is pre-placed on each host that wishes to access memory space on the device. The private key is protected at the level of classification that it grants one access on the data base drive. When the portable data storage device is inserted or connected to a host, it authenticates the host using the public key infrastructure (PKI) operations between the private key of the host and the certificate on the portable data storage device. This authentication signed certificate also grants an associated classification level. Once authenticated, the portable data storage device is capable of writing and reading to the appropriate classified memory space of the non-volatile memory storage.

In addition to the site-based security based on PKI, the portable data storage device utilizes role-based security as well. For example, access to memory areas also may be based on the role of a user, such as a read only user, a read/write user, an administrator, an unauthenticated user, and the like. Actions available to the different users may vary depending on the roles.

The disclosed device may be used within any classified lab or setting that handles sensitive data. Further, the disclosed device may be used to transport any protected and sensitive records, such as health, financial, and education records, as well as meet any applicable standards with regard to the storage and transfer of such records. The disclosed device may leverage existing product lines, hardware assets, and software assets. It also provides improved security over compact discs or other such devices because if the physical object is lost, then the disclosed device provides nothing of value as all data is encrypted based on access key material.

The disclosed device also provides multi-enclave capability as opposed to single-enclave, such as existing pin-code hard drives. Further, it is user-friendly as proof is dependent on the private network and it may relieve the need for a user to remember complex passcodes. It also is compatible with current computing devices, which may not have a CD drive. External CD burning drives also result in additional costs. The disclosed device also may eliminate waste and provide a reusable option for storing sensitive data. It may eliminate the needs for burn once and dispose CDs. The disclosed device also provides greater storage capacity than these items. It also may include the capability to expand the amount of storage instead of being fixed due to limitations of the media, such as a CD. Moreover, writeable CDs and labels may no longer be needed before burning the data onto the CD.

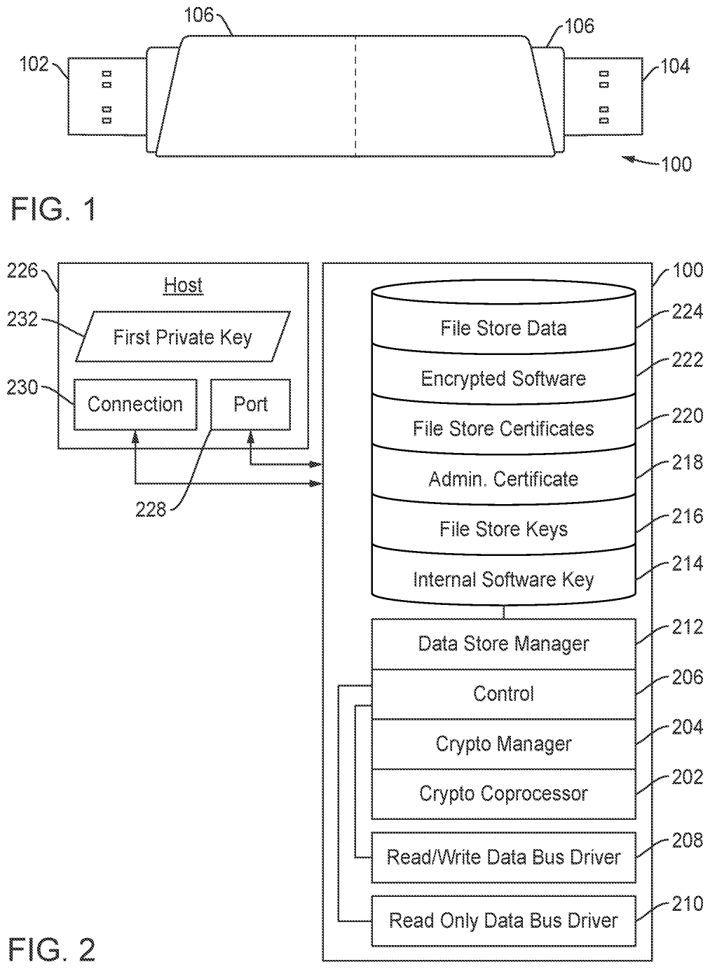

FIG. 1 depicts a portable data storage device 100 according to the disclosed embodiments. Storage device 100 includes a read/write data bus interface 102 and a read only data bus interface 104. Data bus interfaces 102 and 104 may plug into a port or connection of a host device in order for the host device to exchange or read data from storage device 100. The internal components of storage device 100 are disclosed in greater detail below. Storage device 100 includes a casing 106 to house the internal components but allows data bus interfaces 102 and 104 to be inserted or connected to a data port of the host device.

Storage device 100 may be used in closed areas for moving data from one location to another. In some embodiments, storage device 100 is hand held or configured as a key fob device to be carried. It also includes dual data bus interfaces to allow for an increased number of data retrieval scenarios.

FIG. 2 depicts a block diagram of components within portable data storage device 100 according to the disclosed embodiments. Storage device 100 may be inserted or connected to port 228 or connection 230 of host device 226, though additional ports and connections may be configured at the host device. Host device 226 may be a computing device that includes data to be written to or from storage device 100. Host device 226 also may include additional features that allows it to set up a link to the internal components of storage device 100.

Storage device 100 includes read/write data bus driver 208 for read/write data bus interface 102. Read/write data bus driver 208 may be installed on storage device 100 to facilitate communication with host device 226, or other hardware/computing devices. Storage device 100 also includes read only data bus driver 210 for read only data bus interface 104. The combination of read only data bus interface 104 and read only data bus driver 210 allows for control of the access to the data on storage device 100. This feature does not allow bits over the circuit board from host device 226 to storage device 100 within read only data bus interface 104. If read only data bus interface 104 is connected to host device 100, then any write lines are not enabled over the interface.

When storage device 100 is connected to host device 226, power is provided through the appropriate interface to control 206. Control 206 may be a control processor. Control 206 ensures that storage device 100 gets configured and communicates with crypto manager 204 to bring the device into a secure state. Control 206 also may perform a test of file store data 224 to make sure the data is valid and not corrupt. Control 206 also presents storage device 100 to host device 226 as a storage device. If storage device 100 is a USB storage device, then control 206 presents it as a USB storage device.

Data store manager 212 enables the storing and retrieving data from the flash memory storing file store data 224. It also manages the partitions of data within file store data 224. Data store manager 212 also ensures the data being read is valid and not corrupt. Data store manager 212 also stores and reads data from file store data 224 to and from host device 226. In order to improve processing, these functions may be kept separate from control 206 along with management of the partitions within file store data 224.

Cryptographic, or crypto, manager 204 and crypto coprocessor 202 performs the cryptographic, encryption, decryption, and authentication operations within storage device 100. Crypto manager may act as a mini-controller in performing these operations. Functions performed by crypto manager 204 and crypto coprocessor 202 also alleviate the burden on control 206 to manage encryption/decryption and authentication operations. These components may check the integrity of the data within file store data 224 to make sure every bit of data is in its proper place.

Internal software key 214 provides protection for the software on storage device 100 from analysis and attack. Internal software key 214 may be encrypted boot code or application code. Software on storage device 100, at rest, is encrypted. File store certificates and keys are generated and pre-placed such that the file store certificates on the device and file store private keys on the networks correlate to one another, one for each at a given classification.

File store keys 216 includes the keys that protect the files and data on storage device 100. The number of file store keys may match the number of partitions of data within file store data 224. File store keys 216 also may be based on classification levels. The keys are stored in storage device 100. File store keys 216 help protect file store data 224. File store keys 216 also may relate to the classification levels.

Administrative certificate 218 is a high level certification for an administrator that needs access to storage device 100 from time to time. This access does not include access to any data stored on storage device 100, especially in file store data 224. Administrative certificate 218 allows the administrator to load new certificates in file store certificates 220 and create new file stores having file store data 224. Administrators may manage access to storage device 100 itself but not access any data thereon. Control 206 and file store keys 216 control access to the partitioned data within file store data 224 but not the items to allow access to the data.

File store certificates 220 may be a list of certificates for the private file stores in file store data 224. These certificates may correspond to file store keys 216 used to access data within file store data 224. File store certificates 220 may be used as part of the public key infrastructure (PKI) operations to allow access to partitions of data within file store data 224.

Encrypted software 222 may be the executable boot code or application code that resides on a memory of storage device 100. When storage device 100 is powered on and booted, the boot code of encrypted software 222 decrypts the application using memory resident boot keys. If they are unavailable, then storage device 100 will not boot. This feature reduces the attack vectors by which one could analyze and thwart protections for storage device 100. It also allows for storage device 100 to be transferred unclassified when not powered on and in between locations.

File store data 224 may be the non-volatile memory, or flash memory, that is used to store data on storage device 100. Depending on the access level, partitions of data may be written or read from file store data 224. Data store manager 212 may manage access to file store data 224 using file store keys 216. File store data 224 may be disclosed in greater detail below.

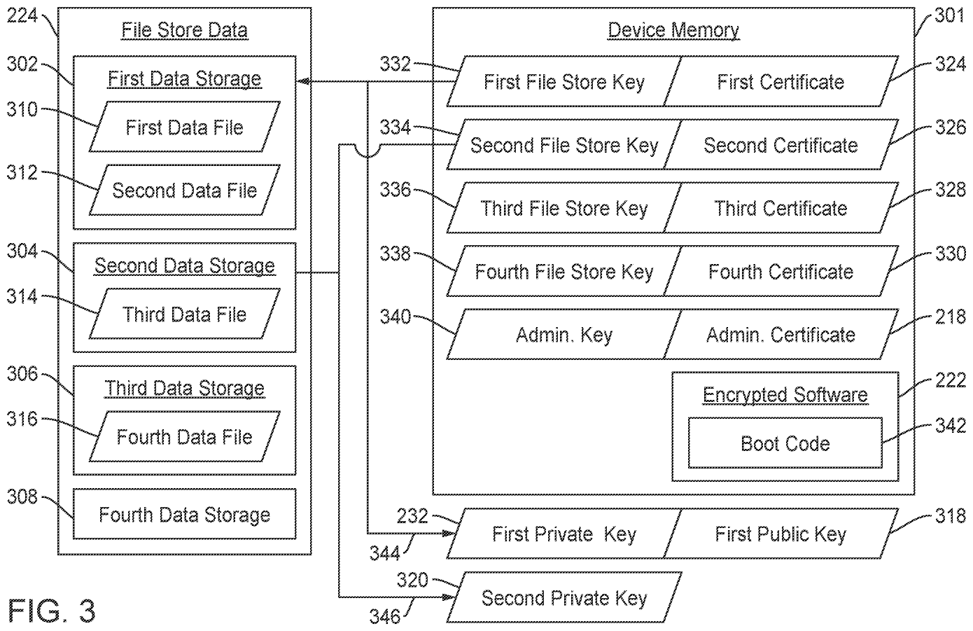

In some embodiments, host device 226 receives storage device 100 and provide power to the device to enable operations. Host device 226 includes first private key 232 and, alternatively, other private keys for other storage devices, which are preplaced on the host device. After accepting the connection, host device 100 may provide a datablock, signed by first private key 232, to storage device 100. Storage device 100 authenticates the signature on the datablock with first public key 318, thereby verifying host device 226 does indeed control first private key 232 that matches first public key 318. First public key 318 is shown in FIG. 3.

Another private key may be kept and used by host device 226 for a different storage device. This other private key may not be used to access storage device 100 as it does not match first private key 232. Alternatively, the other private key also may have a different classification level in that host device 226 accesses a different classification level on another device apart from storage device 100.

FIG. 3 depicts a block diagram of components during access of portable data storage device 100 according to the disclosed embodiments. The components may show the operations performed in authenticating a host device to access data within file store data 224. These operations may occur within storage device 100 within data received from a host device, such as host device 226.

File store data 224 may be partitioned into separate memory spaces. As disclosed above, file store data 224 may be non-volatile memory storage. For example, file store data 224 may be partitioned into first data storage 302, second data storage 304, third data storage 306, and fourth data storage 308. Each data storage space has its own classification level in that files stored within the respective data storage are at the classification level. Access to the different data storages is controlled using file store certificates 220, first store keys 216, and private and public keys received from the host devices.

First data storage 302 may include first data file 310 and second data file 312. Second data storage 304 may include third data file 314. Third data storage 306 may include fourth data file 316. Fourth data storage 308 may have not any data files stored thereon. Access to the specific data file comes through access to the respective data storage. For example, access to second data storage 304 allows access to third data file 314 but not to first data file 310, second data file 312, or fourth data file 316.

Further, access only allows host device 226 to write data files to the associated data storage. Thus, access to first data storage 302 does not allow host device 226 to write files to fourth data storage 308. Data store manager 212 may manage size of the data storages in that if fourth data file 316 requires more memory space, then third data storage 306 may be allocated more memory space within file store data 224. The space for fourth data file 316, however, may not be allocated to first data storage 302, second data storage 304, or fourth data storage 308.

Device memory 301 may be the memory storage for features used to authenticate or to administer access to file store data 224. For example, device memory 301 also may be non-volatile memory but it is not accessed using private keys from host devices, unless it is an administrative key. This memory may store file store certificates 220 and file store keys 216. The process of using these to enable operations using file store data 224 is disclosed below.

Device memory 301 also includes administrative certificate 218 along with an administrative key 340. In some embodiments, administrative key 340 may be managed with file store keys 216. Device memory 301 also may include encrypted software 222, disclosed above. Encrypted software 222 may include boot code 342 to decrypt the application code with memory resident boot keys or keys from the network used by control 206 and other components to perform authentication and access operations. If boot code 342 is not available, or the keys not received, then the application code does not launch and access not made available to any feature within storage device 100.

When storage device 100 is in communication with a host device, it receives private and public keys using a PKI system. A given domain has a classification level tied to the private key. The private key may establish the identity for the host device while the public key is used to verify the identity. PKI operations govern the issuance of digital certificates to protect sensitive data, provide unique digital identities for host devices, and secure end-to-end communications between storage device 100 and a host device. The private and public keys may establish a unique digital identity for the host device.

First private key 232 is received from host device 226 along with first public key 318. First public key 318 also may relate to host device 226. First private key 232 and first public key 318 may apply to a given domain and provide a unique digital identity to host device 226. The disclosed embodiments retrieve the stored file store key from file store keys 216 to authenticate first private key 232. First public key 318 may be used to identify which file store key to retrieve. For example, first file store key 332 may be retrieved based on first public key 318 being associated with host device 226 and first file store key 332 also being associated with host device 226. The disclosed embodiments determine that first private key 232 corresponds to first file store key 332 so that authentication is completed.

First file store key 332 corresponds first certificate 324 of file store certificates 220. First certificate 324 certifies the classification level of the data storage available for first file store key 332. For example, first data storage 302 is associated with keys and a certificate. These include first file store key 332, first certificate 324, private key 232, and public key 318. First private key 232 and first file store certificate are mathematically related to each other, through the PKI processes. First file store key 332 and first certificate 324 are logically related to each other, through internal mappings in data store manager 212. First data storage 302 is logically related to first file store key 332 through internal mappings in data store manager 212.

Access to first data storage 302 may occurs as follows. Host device 226 signs with a datablock with first private key 232, and sends the signed datablock to storage device 100. Storage device 100 iterates through each file store certificate of file store certificates 220. Storage device 100 successfully authenticates the signed datablock from host device 226 with first certificate 324. Storage device 100 decrypts first data storage 302 with first file store key 332 and presents the decrypted data, shown as first data file 310 and second data file 312, to host device 226. This same process applies to the keys associated with second data storage 304, which are second file store key 334, second certificate 326, and second private key 320.

This process then establishes a secure end-to-end communication channel 344 between first data storage 302 and host device 226. First certificate 324 also may specify whether communication channel is read/write or read only. These statuses also govern how host device 226 may access first data storage 302. First certificate 324 may specify that first file store key 332 is associated with read/write operations to the applicable data storage in file store data 224 so that it allows host device 226 to read and write to files stored in the applicable data storage. First certificate 324 may specify a secret classification level for first file store key 332 so that communication channel 344 is provided access to first data storage 302, which is associated with the secret classification level data files. First data file 310 and second data file 312 may be documents or files having a clearance of secret.

Establishment of communication channels to the other data storages may occur in the same manner. Second private key 320 may be received from host device 226. Second private key 320 is authenticated as disclosed above using second file store key 334. After authentication using second file store key 334, the disclosed embodiments retrieve second certificate 326 corresponding to second file store key 334 to determine the classification level of the access and which data storage area is applicable. Second certificate 326 indicates that second file store key 334 has a top secret classification level, which corresponds to second data storage 304. Secure end-to-end communication channel 346 may be established to allow the host device providing second private key 320 to access third data file 314. Second certificate 326 also may specify that the private keys associated with second file store key 334 are provide read only operations so that the host device can only read third data file 314. Thus, storage device 100 may present both first data storage 302 and second data storage 304, as a concurrent multi-domain function.

Another private key and public key combination may be received that is authenticated by third file store key 336. Third certificate 328 may be retrieved from file store certificates 220 as it corresponds to third file store key 336. Third certificate 328 indicates the classification level for third file store key 336 is unclassified, which corresponds to third data storage 306. A communication channel using third file store key 336 allows access to unclassified fourth data file 316 within third data storage 306.

Fourth file store key 338 and fourth certificate 330 also may be used as disclosed above. Fourth data storage 308 may correspond to a classification level not yet defined or may be for future use. It also may be used for an existing classification level, such as secret but with a different level of access, such as read only. In some embodiments, fourth data storage 308 may reserved for future use that is accessed using fourth file store key 338 and fourth certificate 330.

In some instances, an administrator may want to access files within device memory 301 that are not part of file store data 224. A private key is received that is authenticated using administrative key 340. Administrative key 340 retrieves administrative certificate 218, which allows the administrator to perform actions on storage device 100 that do not pertain to data files stored within file store data 224. The administrator does not have access to first data storage 302, second data storage 304, third data storage 306, or fourth data storage 308. Conversely, users associated with file store keys 216 may not have administrative privileges to modify certificates, keys, or other data not within file store data 224.

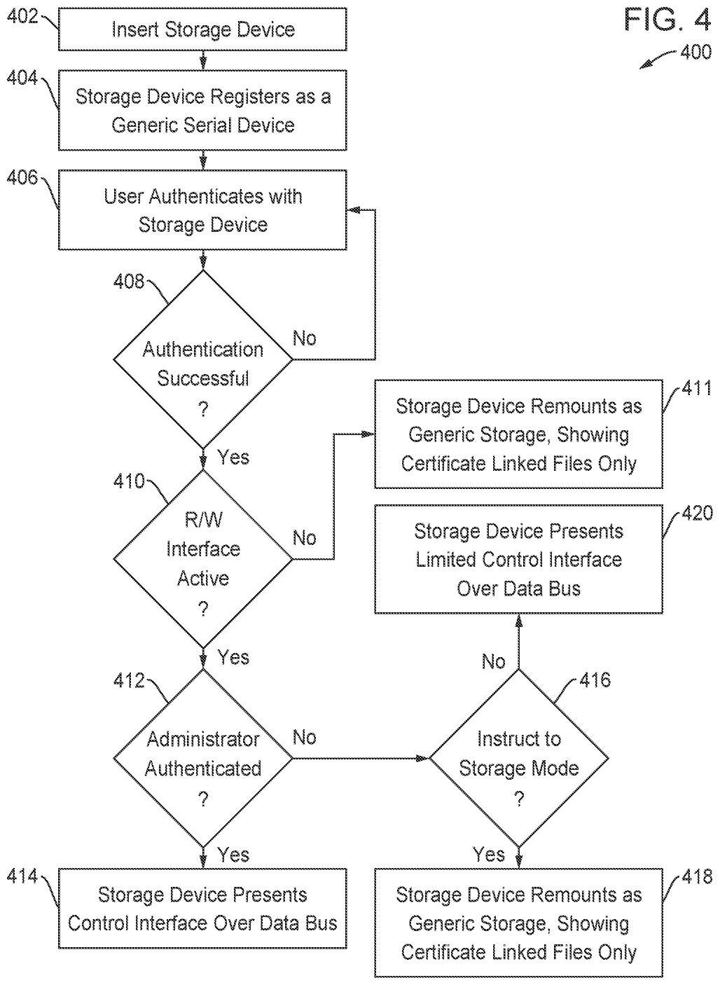

FIG. 4 depicts a flow diagram 400 for enabling multi-level portable secure data storage using cross-domain host-authenticated storage media according to the disclosed embodiments. Flow diagram 400 may refer to FIGS. 1-3 for illustrative purposes. Flow diagram 400, however, is not limited to the embodiments disclosed in FIGS. 1-3.

Operation 402 executes by inserting storage device 100 into host device 226. Storage device 100 may be inserted into port 228 or connection 230. Operation 404 executes by storage device 100 registering as a generic storage device having a data bus to exchange data with host device 226. Operation 406 executes by a user authenticating host device with storage device 100 using a PKI operation, as disclosed above. Host device 226 may provide first private key 232, which is authenticated with first file store key 332. Cryptography manager 204 may perform these operations to control access to file store data 224 and the stored data files.

Operation 408 executes by determining whether the authentication of host device 226 using a private key was successful. If no, then flow diagram 400 returns back to operation 406 to retry authentication using the correct private key. In some embodiments, power to storage device 100 may be terminated or access denied to storage device 100. If operation 408 is yes, then operation 410 executes by determining whether the read/write data bus interface 102 is active. During authentication, a certificate corresponding to the file store key is retrieved from file store keys 216. The certificate will provide information indicating that the attached storage device can perform read and write operations to the non-volatile storage memory.

If operation 410 is yes, then operation 412 executes by determining whether the authentication is for an administrator, or is done using administrative certificate 218. If operation 412 is yes, then operation 414 executes by presenting a control interface for storage device 100 over data bus interface 102. The administrator may perform control functions using the connection established with device memory 301 and host device 226. These control functions may include zeroize or reset operations, certificate management for administrative certificate 218 or file store certificates 220, or software load management, wherein the administrator configures software on storage device 100. This software may include encrypted software 222.

If operation 412 is no, then operation 416 executes by determining whether the associated certificate instructs storage device 100 to operate in storage mode. Storage mode may relate to accessing data storage locations in file store data 224. If operation 416 is yes, then operation 418 executes by remounting storage device 100 as a generic storage, showing only those files linked to the certificate. As disclosed above, the certificate of file store certificates 220 is linked or associated with a data storage, such as first data storage 302. First data file 310 and second data file 312 within first data storage 302 may be shown after first file store key 332 authenticates the private key and retrieves first certificate 324, which is linked to the data files.

Referring back to operation 410, the disclosed process determined that read/write data bus interface 102 is active. Further, first certificate 220 may indicate that the digital identity for host device 226 may read and write to the linked data files. Thus, operation 418 also includes read/write functions. The user may read data files from file store data 224, write to data files from file store data 224, and erase data files from file store data 224.

If operation 416 is no, then operation 420 executes by presenting a limited control interface to storage device 100 over read/write data bus interface 102. The user may perform limited control functions, such as limited certificate management and limited file store data management. The user may not have access to software or functionality on storage device 100.

Referring back to operation 410, if it is determined that read/write data bus interface 102 is not active, then flow diagram 400 proceed to operation 411. The disclosed embodiments determine that read only data bus interface 104 is active. In some embodiments, a certificate may indicate that read/write operations are not allowed for the user or host device presenting the private key and prompts the user to remove storage device 100 from host device 226 and insert it back into the host device with read only data bus interface 104.

In operation 411, storage device 100 remounts as a generic storage device, showing only those data files linked to the certificate associated with the keys used for authentication. Control functions may be limited to read only functions, such as reading data files from file store data 224 in a limited manner. The user or host device 226 may not write or erase data files linked to the certificate. Thus, storage device 100 may enable different control functions for different sets of data files stored on the non-volatile memory.

Referring to flow diagram 400, the following examples of use cases may be provided. A user writes data files onto storage device 100 in a secret lab. First data storage 302 may be associated with the secret classification level so that the data files are stored in this location of file store data 224. The user walks to another secret lab. The data files may be accessed using a host device in the other secret lab for reading and writing operations.

In another example, the user may write data files into storage device 100 in a secret lab. The user goes to a top secret lab. The data files written into the secret lab are not accessible in the top secret lab as the host device there does not present a private key that is associated with a certificate to access the secret data files in file store data 224. Top secret data files, however, are accessible provided second data storage 304 is linked to a certificate.

In another example, the user may write data files onto storage device 100 in a secret lab. The user then enters an unclassified lab. The secret data files are not accessible using a host device in the unclassified lab. Any unclassified files, such as those stored in third data storage 306, are accessible. In another example, the user may write data files onto storage device 100 in a secret lab. The user enters into another secret lab that does not have the proper private keys on the network or in a host device to authenticate to storage device 100. The secret files are not accessible to read or write in this secret lab.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, the present invention may take the form of a computer program product embodied in any tangible medium of expression having computer-usable program code embodied in the medium.

The corresponding structures, material, acts, and equivalents of all means or steps plus function elements in the claims below are intended to include any structure, material or act for performing the function in combination with other claimed elements are specifically claimed. The description of the present invention has been presented for purposes of illustration and description, but is not intended to be exhaustive or limited to the invention in the form disclosed. Many modifications and variations will be apparent to those of ordinary skill without departing from the scope and spirit of the invention. The embodiment was chosen and described in order to best explain the principles of the invention and the practical application, and to enable others of ordinary skill in the art to understand the invention for embodiments with various modifications as are suited to the particular use contemplated.

Modifications and equivalents may be made to the features of the claims without departing from the spirit or scope of the invention. Thus, it is intended that the present invention covers the modifications and variations disclosed above provided that these changes come within the scope of the claims and their equivalents.

1. A method for multi-level portable secure data storage, the method comprising:
configuring a portable data storage device to communicate with a host device using a data bus interface;
receiving a private key at the portable data storage device from the host device, wherein the private key corresponds to a unique digital identity;
authenticating the private key within the portable storage device;
determining the unique digital identity of the private key has access to a storage area of a plurality of storage area within a non-volatile memory storage of the portable data storage device; and
accessing at least one data file within the storage area of the non-volatile memory storage.

2. The method of claim 1, further comprising generating output to the computing device regarding the at least one data file within the storage area.

3. The method of claim 1, further comprising enabling a read/write operation within the storage area according to the unique digital identify of the private key.

4. The method of claim 3, wherein the interface of the portable data storage device enables the read/write operation to the storage area.

5. The method of claim 1, further comprising enabling a read only operation within the storage area according to the unique digital identify of the private key.

6. The method of claim 5, wherein the interface of the portable data storage device enables the read only operation to the storage area.

7. The method of claim 1, wherein the storage area includes an encrypted memory location within the non-volatile memory storage space.

8. The method of claim 1, wherein authenticating the private key includes matching the private key to a certificate stored within the non-volatile memory storage.

9. The method of claim 8, further comprising retrieving the certificate from a certificate storage of the non-volatile memory storage.

10. The method of claim 8, further comprising associating a classification level of the certificate to the private key, wherein the classification level is from a plurality of classification levels.

11. The method of claim 1, further comprising reading or writing to the at least one data file within the storage area of the non-volatile memory storage.

12. A portable data storage device comprising:
a read only data bus interface to exchange data with a host device;
a read/write data bus interface to exchange data with the host device;
a non-volatile memory storage having a plurality of data file storage areas, wherein each of the plurality of data file storage areas is associated with a private key and a certificate;
a certificate storage area within the plurality of data file storage areas of the non-volatile memory storage, wherein the certificate storage area includes the certificate for each data file storage area; and
a cryptography manager to control access to a first data file storage area of the plurality of data file storage areas through the read only data bus interface or the read/write data bus interface upon receipt of a first private key that matches a first certificate within the certificate storage corresponding to the first data file storage area.

13. The portable data storage device of claim 12, further comprising a control module to enable power to the portable data storage device and to bring the cryptography manager into a secure state.

14. The portable data storage device of claim 12,
wherein the first certificate is an administrator certificate related to the certificate storage area,
wherein the cryptography manager determines that the first private key is associated with the administrator certificate, and
wherein the cryptography manager enables access only to the certificate storage area for the first private key.

15. The portable data storage device of claim 12, wherein the cryptography manager determines a classification level of a plurality of classification levels for the first certificate and that the first data file storage area has the classification level.

16. The portable data storage device of claim 12, wherein the plurality of data file storage areas includes a second data file storage area corresponding to a second certificate within the certificate storage area.

17. The portable data storage device of claim 16, wherein the cryptography manager controls access to the to the second data file storage area of the plurality of data file storage areas through the read only data bus interface or the read/write data bus interface upon receipt of a second private key that matches the second certificate within the certificate storage.

18. A method for secure multi-level portable secure data storage, the method comprising:
configuring a portable data storage device to communicate with a host device using one of a read only data bus interface and a read/write data bus interface;
receiving a first private key at the portable data storage device from the host device, wherein the private key corresponds to a unique digital identity;
authenticating the first private key within the portable storage device using a cryptographic manager by matching the first private key to a first certificate stored within a certificate storage of a non-volatile data storage of the portable storage device;
determining a first data file storage having at least one data file corresponds to the first certificate;
determining a first access status for the first data file storage according to the first certificate; and
enabling access to the first data file storage using the read only data bus interface or the read/write data bus interface based on the first access status.

19. The method of claim 18, further comprising
receiving a second private key at the portable data storage device;
authenticating the second private key using the cryptographic manager by matching the second private key to a second certificate stored with the certificate storage;
determining a second data file storage having at least one data file corresponds to the second certificate;
determining a second access status for the second data file storage according to the second certificate, wherein the second access status differs from the first access status; and
enabling access to the second data file storage using the read only data bus interface or the read/write data bus interface based on the second access status.

20. The method of claim 18, wherein enabling access to the first data file storage includes granting a certificate level to the first private key based on the first certificate.
